(19) United States
(12) Patent Application Publication
(10) Pub. No.: US 2026/0111452 A1
(43) Pub. Date: Apr. 23, 2026

(54) SYSTEMS AND METHODS FOR MAKING APPLICATION FEATURES DISCOVERABLE ON MOBILE DEVICES UNIQUE TO USER PERSONA

(71) Applicant: JPMORGAN CHASE BANK, N.A., New York, NY (US)

(72) Inventors: Aditya CHEBIYYAM, McKinney, TX (US); Pradeep GANGABHATHINA, Frisco, TX (US); Rajitha DISSANAYAKE, Frisco, TX (US); Sudharsan SELVAKUMAR, Irving, TX (US); Srinivasavaibhav KALLURI, McKinney, TX (US)

(21) Appl. No.: 19/364,952

(22) Filed: Oct. 21, 2025

Related U.S. Application Data
(60) Provisional application No. 63/710,480, filed on Oct. 22, 2024.

(51) Int. Cl. G06F 16/28; G06F 16/3329; G06Q 30/0201

(52) U.S. Cl. CPC G06F 16/288; G06F 16/285; G06F 16/3329; G06Q 30/0201

(57) ABSTRACT

A method may include: retrieving, by a computer application executed by a user electronic device for a user, a persona for the user, wherein the persona is based on user transactions and/or user inquiries to the computer application; retrieving, by the computer application and using a personalization system, application features for the computer application that are relevant to the persona; retrieving, by the computer application, localized content for the application features; translating, by the computer application, the application features into entity objects; and providing, by the computer application, the entity objects and the localized content to an operating system for the user electronic device. The operating system surfaces one of the application features and displays the localized content in response to a user search in a search interface provided by the operating system by searching the entity objects, and to controls the computer application to present the application feature.

### RELATED APPLICATIONS

This application claims priority to, and the benefit of, U.S. Provisional Patent Application Ser. No. 63/710,480, filed Oct. 22, 2024, the disclosure of which is hereby incorporated, by reference, in its entirety.

### BACKGROUND OF THE INVENTION

### 1. Field of the Invention

Embodiments relate to systems and methods for making application features discoverable on mobile devices unique to user personas.

### 2. Description of the Related Art

As a user navigates a mobile electronic device, such as using a search feature, certain features may not be easily discoverable. This may lead to the user missing an opportunity to use a feature that may address the user's issue.

### SUMMARY OF THE INVENTION

Systems and methods for making application features discoverable on mobile devices unique to user personas are disclosed. According to an embodiment, a method may include: (1) retrieving, by a computer application executed by a user electronic device for a user, a persona for the user, wherein the persona may be based on user transactions and/or user inquiries to the computer application; (2) retrieving, by the computer application and using a personalization system, application features for the computer application that are relevant to the persona; (3) retrieving, by the computer application, localized content for the application features; (4) translating, by the computer application, the application features into entity objects; and (5) providing, by the computer application, the entity objects and the localized content to an operating system for the user electronic device. The operating system may be configured to surface one of the application features and display the localized content in response to a user search in a search interface provided by the operating system by searching the entity objects, and to control the computer application to present the application feature.

In one embodiment, the method may also include: receiving, by a backend computer program, a plurality of data points for a plurality of customers; clustering, by the backend computer program, the data points into a plurality of clusters using a clustering algorithm; identifying, by the backend computer program, a persona for each of the clusters; receiving, by the backend computer program, a plurality of user data points for the user; identifying, by the backend computer program, one of the clusters for the plurality of user data points; and returning, by the backend computer program, the persona for the identified cluster to the computer application.

In one embodiment, the data points and the user data points comprise average monthly spends, spending categories, spending patterns, financial products owned, benefits/offers exploration/redemption rate, and/or application feature usage.

In one embodiment, the personas are based on a common feature in each of the clusters.

In one embodiment, the clusters are updated periodically.

In one embodiment, the user data points are limited to a time period.

In one embodiment, the localized content may include a description for each of the application features.

According to another embodiment, a system may include: a user electronic device executing an operating system and a computer application; a computer application executed by a user electronic device; and a backend electronic device executing a backend computer program and a personalization system and comprising an application features database and a localized content database. The computer application may be configured to retrieve, for a user, a persona for the user, wherein the persona may be based on user transactions and/or user inquiries to the computer application; the computer application may be configured to retrieve, via the personalization system, application features for the computer application that are relevant to the persona from the application features database; the computer application may be configured to retrieve localized content for the application features from the localized content database; the computer application may be configured to translate the application features into entity objects; and the computer application may be configured to provide the entity objects and the localized content to the operating system. The operating system may be configured to surface one of the application features and display the localized content in response to a user search in a search interface provided by the operating system by searching the entity objects, and to control the computer application to present the application feature.

In one embodiment, the backend computer program may be configured to receive a plurality of data points for a plurality of customers; the backend computer program may be configured to cluster the data points into a plurality of clusters using a clustering algorithm; the backend computer program may be configured to identify a persona for each of the clusters; the backend computer program may be configured to receive a plurality of user data points for the user; the backend computer program may be configured to identify one of the clusters for the plurality of user data points; and the backend computer program may be configured to return the persona for the identified cluster to the computer application.

In one embodiment, the data points and the user data points comprise average monthly spends, spending categories, spending patterns, financial products owned, benefits/offers exploration/redemption rate, and/or application feature usage.

In one embodiment, the personas are based on a common feature in each of the clusters.

In one embodiment, the clusters are updated periodically.

In one embodiment, the user data points are limited to a time period.

In one embodiment, the localized content may include a description for each of the application features.

According to another embodiment, a non-transitory computer readable storage medium may include instructions stored thereon, which when read and executed by one or more computer processors, cause the one or more computer processors to perform steps comprising: retrieving a persona for a user, wherein the persona may be based on user transactions and/or user inquiries to a computer application; retrieving, using a personalization system, application features for the computer application that are relevant to the persona; retrieving, localized content for the application features, wherein the localized content may include a description for each of the application features; translating the application features into entity objects; surfacing one of the application features and displaying the localized content in response to a user search in a search interface by searching the entity objects; and presenting to present the application feature.

In one embodiment, the non-transitory computer readable storage medium may also include instructions stored thereon, which when read and executed by the one or more computer processors, cause the one or more computer processors to perform steps comprising: receiving a plurality of data points for a plurality of customers; clustering the data points into a plurality of clusters using a clustering algorithm; identifying a persona for each of the clusters; receiving a plurality of user data points for the user; and identifying one of the clusters for the plurality of user data points.

In one embodiment, the data points and the user data points comprise average monthly spends, spending categories, spending patterns, financial products owned, benefits/offers exploration/redemption rate, and/or application feature usage.

In one embodiment, the personas are based on a common feature in each of the clusters.

In one embodiment, the clusters are updated periodically.

In one embodiment, the user data points are limited to a time period.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for making application features discoverable on mobile devices unique to user personas according to an embodiment;

FIG. 2 illustrates a method for making application features discoverable on mobile devices unique to user personas according to an embodiment;

FIG. 3 depicts an exemplary computing system for implementing aspects of the present disclosure.

### DETAILED DESCRIPTION OF PREFERRED EMBODIMENTS

Embodiments relate to systems and methods for making application features discoverable on mobile devices unique to user personas.

Embodiments may use a user's persona, which may be based on past transactions, past searches, application features, offers, etc. As used herein, a “persona” is categorization of a customer based on the customer's spending patterns and other customer interactions with, for example, a financial institution. Examples of personas may include a travel avid customer, a customer starting a new family, a customer that is looking to purchase, or has recently purchased, a house, etc.

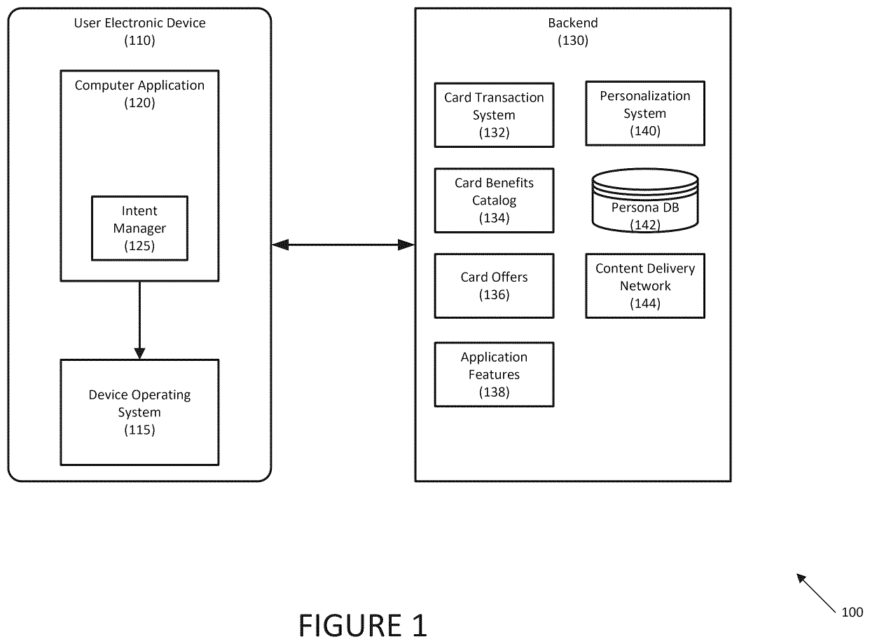

Referring to FIG. 1, a system for making application features discoverable on mobile devices unique to user personas is disclosed according to an embodiment. System 100 may include user electronic device 110, which may be a computer (e.g., workstation, desktop, laptop, tablet, etc.), a smartphone, a smart watch, a tablet computer, etc. User electronic device 110 may execute operating system 115 and computer application 120. Computer application 120 may be provided by backend 130, such as a backend for a financial institution or any other suitable organization.

Computer application 120 may execute intent manager 125, which may be a standalone framework that may be integrated within computer application 120. The framework may include functionality to communicate with, for example, personalization system 140 and content delivery network 144. Intent manager 125 may also interact with device operating system 115 using the framework.

Personalization system 140 and content delivery network 144 may be computer programs executed by backend 130. Personalization system 140 may be an application that receives information from backend 130, such as from card transaction system 132, card benefits catalog 134, card offers 136, etc. to create a persona for the user of user electronic device 110. Backend 130 may provide information, such as a past transaction information, benefits that are available to credit cards that the user holds, offers that the user may be eligible for, etc.

Database 142 may store personas and updates to personas. The personas may be associated with a user identifier for the user.

In one embodiment, catalog of application features 138 may identify features available to computer application 120. A history of the user's interactions with the application features may be saved and used as an input to personalization system 140.

Once personalization system 140 has created a persona for a user, it may identify application features that are relevant to the persona, and may provide the relevant application features to intent manager 125. Intent manager 125 may then retrieve localized content for the application features.

Localized content may include the text presented to users in response to a search. It may be based on a content ID from personalization system 140. Content delivery network 144 may be a backend system that hosts content or assets, like images, for display on front-end applications (e.g., computer application 120), including those linked to the content ID. The content ID may be associated with one of the application features 138.

Intent manager 125 may translate the application features into entity objects for operating system 115. Entity objects are model objects that hold information about computer application 120's data, such as a personalized application feature that is submitted to device. Intent manager may send the application features to operating system 115. Operating system 115 may use the entity objects to resolve search queries and return relevant results, so that when the user enters a query into a search interface provided by the operating system (e.g., a spotlight search in iOS, a search feature in Android), operating system 115 may identify entity objects responsive to the query along with localized content.

In one embodiment, operating system 115 may maintain the entity objects.

When operating system 115 receives a query, it may perform a semantic search on available entity objects on user electronic device 110. The semantic search filters the entity object(s) to return. In one embodiment, the entity objects may be ranked.

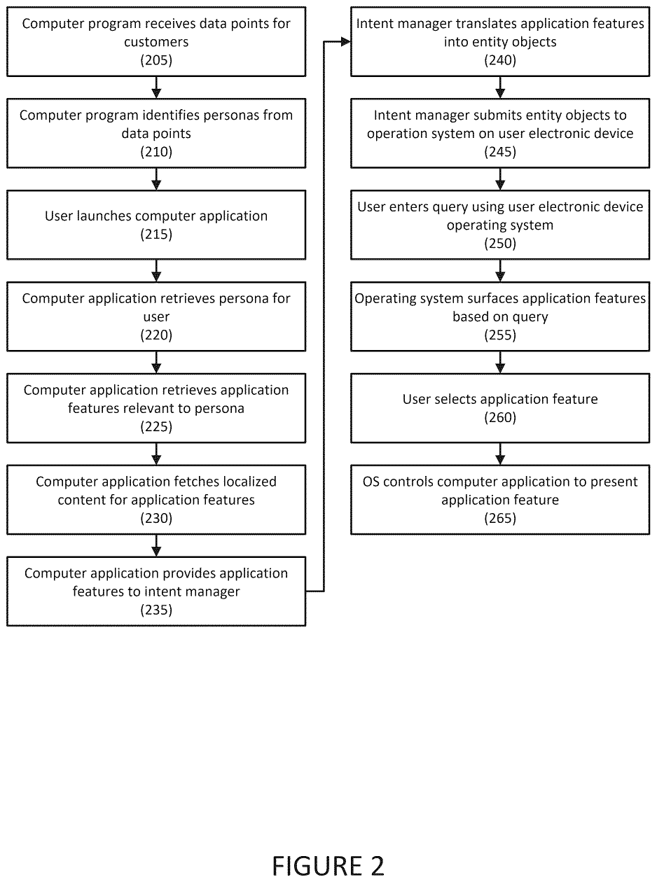

Referring to FIG. 2, a method for making application features discoverable on user devices unique to user personas is disclosed according to an embodiment.

In step 205, a computer program, such as a backend computer program, may receive a plurality of data points for customers of, for example, a financial institution. For example, the backend computer program may retrieve data points for the customers, such as average monthly spends, spending categories, spending patterns, financial products owned, benefits/offers exploration/redemption rate, application feature usage based on analytics, etc. In one embodiment, the data points may be normalized to be on a comparable scale.

In step 210, the computer program may identify a plurality of personas from the data points. For example, the personas may be identified from the data points, and may not be predefined or available as labels. The data points may be used to train an unsupervised machine learning model, such as a clustering algorithm.

Once clusters are formed, the computer program may identify a persona for each cluster based on a common feature of the customers in the cluster. Examples of personas may include digital savvy customers, avid travelling customers, offer redeeming customers, multi-product holder customers, affluent customers, etc.

In one embodiment, the personas may be updated periodically, such as hourly, daily, weekly, etc. or whenever a new trend in spending or interaction is identified.

In step 215, a user may launch a computer application that is executed by a user electronic device, and, in step 220, the computer application may identify one of the clusters for the user. In one embodiment, the data points for the user may be limited to a certain time period (e.g., data points since the last login, data points for the past hour, day, week, month, etc.) in order to account for changing user personas.

The computer application may retrieve a persona each time the computer application is launched so that the most current persona is used.

In step 225, the computer application may retrieve application features relevant to the identified persona. Each persona may be associated with one or more application features. The application features may be manually identified, or they may be identified using machine learning based on application features accessed by the customers in the persona cluster.

For example, for an avid travelling customers, application features may include travel planning services, reward earning or redemption features, hotel reservation features, flight reservation features, co-branded products, etc. For home purchasing personas, application features may include mortgage application features, home insurance information, partner merchant features, etc.

In step 230, the computer application may fetch relevant localized content for the application features from a content delivery network. For example, each application feature may be associated with a content identifier that may be used to retrieve localized content for the application feature. The localized content may be a description of the application feature that is displayed in response to a search, such as “Travel—Most rewarding trips start here”, “Delivery—Sign up for complimentary delivery service membership” etc.

The content in content delivery network may be populated with content when new application features are set up.

In step 235, the computer application may provide the application features and the localized content to an intent manager that may be executed by the user electronic device. The intent manager may be integrated into the computer application.

In step 240, the intent manager may translate the application features into entity objects for the operating system. For example, the intent manager may create entity objects (e.g., model objects) with all the necessary properties for the operating system to identify features. Entity objects include information related to application features that help the operating system show these objects in search results.

In one embodiment, when the entity objects are created, the intent manager will populate localized content so that it can be displayed in response to a search.

In step 245, the intent manager may submit the entity objects to operation system on the user electronic device. The operating system may store the entity objects in a typical manner.

The number of entity objects may be limited by the operating system, or may be limited by the application. Thus, the use of personas pre-stages the most likely application features (via entity objects) that the user may search for in a search interface provided by the operating system.

In one embodiment, the most common application features that may be generic to multiple personas may be provided as entity objects. The entity objects for these common application features may be provided with the entity objects for the persona, or they may be static.

In step 250, the user may enter a query using a search interface provided by the operating system, and in step 255, the operating system may use the entity objects to resolve search queries and return relevant results. In one embodiment, the operating system may use the metadata within the entity object to include application features in search results and display localized content to the user.

For example, the operating system may perform a semantic search on the entity objects submitted by applications. The properties of these entity objects contain text that operating system will query.

In one embodiment, the available application features may be ranked, with application features associated with the persona ranked higher than application features that are not.

Once features are surfaced, in step 260, the user may select one of the application features. In step 265, the operating system may cause the computer application to present the application feature to the user.

The process may be repeated, for example, each time the user launches the computer application, periodically, or as necessary and/or desired. The application features and localized content may be updated in this manner.

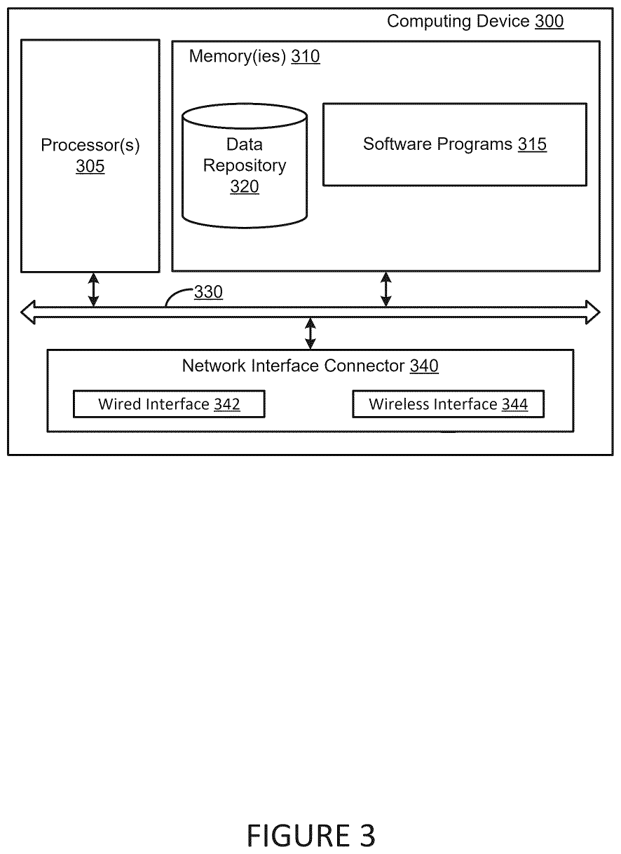

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
retrieving, by a computer application executed by a user electronic device for a user, a persona for the user, wherein the persona is based on user transactions and/or user inquiries to the computer application;
retrieving, by the computer application and using a personalization system, application features for the computer application that are relevant to the persona;
retrieving, by the computer application, localized content for the application features;
translating, by the computer application, the application features into entity objects; and
providing, by the computer application, the entity objects and the localized content to an operating system for the user electronic device;
wherein the operating system is configured to surface one of the application features and display the localized content in response to a user search in a search interface provided by the operating system by searching the entity objects, and to control the computer application to present the application feature.

2. The method of claim 1, further comprising:
receiving, by a backend computer program, a plurality of data points for a plurality of customers;
clustering, by the backend computer program, the data points into a plurality of clusters using a clustering algorithm;
identifying, by the backend computer program, a persona for each of the clusters;
receiving, by the backend computer program, a plurality of user data points for the user;
identifying, by the backend computer program, one of the clusters for the plurality of user data points; and
returning, by the backend computer program, the persona for the identified cluster to the computer application.

3. The method of claim 2, wherein the data points and the user data points comprise average monthly spends, spending categories, spending patterns, financial products owned, benefits/offers exploration/redemption rate, and/or application feature usage.

4. The method of claim 2, wherein the personas are based on a common feature in each of the clusters.

5. The method of claim 2, wherein the clusters are updated periodically.

6. The method of claim 2, wherein the user data points are limited to a time period.

7. The method of claim 1, wherein the localized content comprises a description for each of the application features.

8. A system, comprising:
a user electronic device executing an operating system and a computer application;
a computer application executed by a user electronic device; and
a backend electronic device executing a backend computer program and a personalization system and comprising an application features database and a localized content database;
wherein:
the computer application is configured to retrieve, for a user, a persona for the user, wherein the persona is based on user transactions and/or user inquiries to the computer application;
the computer application is configured to retrieve, via the personalization system, application features for the computer application that are relevant to the persona from the application features database;
the computer application is configured to retrieve localized content for the application features from the localized content database;
the computer application is configured to translate the application features into entity objects; and
the computer application is configured to provide the entity objects and the localized content to the operating system;
wherein the operating system is configured to surface one of the application features and display the localized content in response to a user search in a search interface provided by the operating system by searching the entity objects, and to control the computer application to present the application feature.

9. The system of claim 8, wherein:
the backend computer program is configured to receive a plurality of data points for a plurality of customers;
the backend computer program is configured to cluster the data points into a plurality of clusters using a clustering algorithm;
the backend computer program is configured to identify a persona for each of the clusters;
the backend computer program is configured to receive a plurality of user data points for the user;
the backend computer program is configured to identify one of the clusters for the plurality of user data points; and
the backend computer program is configured to return the persona for the identified cluster to the computer application.

10. The system of claim 9, wherein the data points and the user data points comprise average monthly spends, spending categories, spending patterns, financial products owned, benefits/offers exploration/redemption rate, and/or application feature usage.

11. The system of claim 9, wherein the personas are based on a common feature in each of the clusters.

12. The system of claim 9, wherein the clusters are updated periodically.

13. The system of claim 9, wherein the user data points are limited to a time period.

14. The system of claim 8, wherein the localized content comprises a description for each of the application features.

15. A non-transitory computer readable storage medium, including instructions stored thereon, which when read and executed by one or more computer processors, cause the one or more computer processors to perform steps comprising:
retrieving a persona for a user, wherein the persona is based on user transactions and/or user inquiries to a computer application;
retrieving, using a personalization system, application features for the computer application that are relevant to the persona;
retrieving, localized content for the application features, wherein the localized content comprises a description for each of the application features;
translating the application features into entity objects;
surfacing one of the application features and displaying the localized content in response to a user search in a search interface by searching the entity objects; and
presenting to present the application feature.

16. The non-transitory computer readable storage medium of claim 15, further including instructions stored thereon, which when read and executed by the one or more computer processors, cause the one or more computer processors to perform steps comprising:
receiving a plurality of data points for a plurality of customers;
clustering the data points into a plurality of clusters using a clustering algorithm;
identifying a persona for each of the clusters;
receiving a plurality of user data points for the user; and
identifying one of the clusters for the plurality of user data points.

17. The non-transitory computer readable storage medium of claim 16, wherein the data points and the user data points comprise average monthly spends, spending categories, spending patterns, financial products owned, benefits/offers exploration/redemption rate, and/or application feature usage.

18. The non-transitory computer readable storage medium of claim 16, wherein the personas are based on a common feature in each of the clusters.

19. The non-transitory computer readable storage medium of claim 16, wherein the clusters are updated periodically.

20. The non-transitory computer readable storage medium of claim 16, wherein the user data points are limited to a time period.
